(19) United States
(12) Patent Application Publication
(10) Pub. No.: US 2005/0207284 A1
(43) Pub. Date: Sep. 22, 2005

(54) Wristwatch

(76) Inventors: Haruki Hiranuma, Chiba-shi (JP); Nobukazu Omori, Chiba-shi (JP)

Correspondence Address: BRUCE L. ADAMS, ESQ., 50 BROADWAY-31ST FLOOR, NEW YORK, NY, 10004, US

(21) Appl. No.: 11/086,811

(22) Filed: Mar. 21, 2005

(30) Foreign Application Priority Data
Mar. 22, 2004 (JP) 2004-082212

(51) Int. Cl. B65D 41/00; B65D 39/00; B65D 43/00; B65D 51/00; B65D 47/00; G04B 37/00

(52) U.S. Cl. 368/282

(57) ABSTRACT

To provide a wristwatch in which a band can be easily attached to or detached from a timepiece armor assembly. In a band connection part of a timepiece armor assembly, there are provided respectively a connection groove which opens respectively to a back face 11a and an end face of this connection part and whose interior is formed wider than an open end of the end face, and an engagement groove opening to the former groove. A fit part having a shape coinciding with the connection groove and detachably fitted to the connection groove is provided in an end part of a band attached to or detached from the band connection part. An engagement member, which is protruded into or retracted form an opposed face facing on the engagement groove under a state that the fit part has been fitted to the connection groove and thereby inserted into or detached from the engagement groove, is attached to the fit part. An engagement/disengagement operation body, which has an operation part disposed in an exposed face of the fit part exposed in the back face of the band connection part under the state that the fit part has been fitted to the connection groove, is attached to the fit part. The engagement member is attached to the engagement/disengagement operation body.

### BACKGROUND OF THE INVENTION

1. Field of the Invention

The present invention relates to a wristwatch in which a band has been detachably connected to a timepiece armor assembly.

2. Description of the Prior Art

Hitherto, the band is detachably attached to the timepiece armor assembly by using a spring bar inserted through an axle insertion part provided in an end part of the band (for example, refer to Patent Document 1).

Specifically, the spring bar has in its both ends movable pins, and is formed by building therein a coil spring biasing these movable pins in a direction separating each other. The band is attached to the timepiece armor assembly by inserting one movable pin of this spring bar into one of stop holes respectively provided in one pair of bow feet of the timepiece armor assembly, and thereafter inserting the other movable pin into the other of the stop holes. Reversely to this, it is possible to detach the band from the timepiece armor assembly by pulling out the movable pin from the stop hole by moving this pin while resisting against the coil spring by catching a tool for exclusive use to an engagement part consisting of a flange provided in the movable pin.

Further, hitherto, there is known a wristwatch in which, in order to make a band exchange easy, an insertion fit hole with a slit is provided in an end piece of the band, a spring bar having a pull means to be passed through the slit is inserted into this insertion fit hole and fixed thereto, and the band has been detachably attached to the timepiece armor assembly through this spring bar (for example, refer to Patent Document 2).

In this wristwatch of the Patent Document 2, in order to attach the band to the timepiece armor assembly, first, an one end fixation pin that the spring bar has is inserted into one of the stop holes respectively provided in one pair of leg rods (bow feet) of the timepiece armor assembly. Next, the end piece is disposed between the above one pair of leg rods (bow feet) by retracting the other movable pin biased by a spring of the spring bar from the other end of the spring bar by the pull means. Finally, the band is attached to the timepiece armor assembly by inserting the above movable pin into the other stop hole by removing a restriction of the pull means. Reversely to this, it is possible to detach the band from the timepiece armor assembly by pulling out the movable pin from the above other stop hole and retracting it from the other end of the spring bar by operating the pull means between the above one pair of leg rods (bow feet), and thereafter pulling out the above fixation pin from the above one stop hole.
<Patent Document 1>
JP-A-11-127921 Gazette
<Patent Document 2>
JP-A-11-146804 Gazette

In the Patent Document 1, when attaching or detaching the band to or from the timepiece armor assembly, a work must be performed in a space between one pair of bow feet of the timepiece armor assembly, in other words, within a bow crotch a limited slight interstice between an axle end of a large diameter axle part of the spring bar and the bow foot opposed to the axle end at a very short distance, so that the bow foot becomes an obstacle and thus an operation property for attaching or detaching the band is bad. Moreover, in this attachment/detachment operation, there is required a tool for exclusive use such as a driver for timepiece or a pincette and, from such situations, it is difficult for a general user to easily attach or detach the band to or from the timepiece armor assembly.

In the Patent Document 2, when attaching or detaching the band to or from the timepiece armor assembly, the work must be performed in an elongate interstice between an interior face of the bow crotch and the end piece of the band facing on the interior face at the very short distance, although not a slight interstice limited between the large diameter axle part of the spring bar and the bow foot within the bow crotch. For this reason, by the fact that the pull means has been provided in the spring bar, although an improvement of a certain degree in the work can be recognized, there is no change in the fact that a work space is narrow by being stipulated by the timepiece armor assembly, and thus the interior face of the bow crotch becomes the obstacle, so that the operation property for attaching or detaching the band is not good.

An object of the present invention is to provide a wristwatch in which the band can be easily attached to or detached from the timepiece armor assembly.

### SUMMARY OF THE INVENTION

In order to solve the above problems, the present invention is one in which in a band connection part of a timepiece armor assembly, there are provided respectively a connection groove which opens respectively to a front face or a back face and an end face of this connection part and whose interior has been formed wider than an open end of the end face, and an engagement groove opening to this connection groove, a fit part detachably fitted to the connection groove is provided in an end part of a band attached to or detached from the band connection part, an engagement member, which is protruded into or retracted form an opposed face facing on the engagement groove under a state that the fit part has been fitted to the connection groove and thereby inserted into or detached from the engagement groove, is attached to the fit part, an engagement/disengagement operation body, which has an operation part disposed in an exposed face of the fit part exposed in the back face or the front face of the band connection part under the state that the fit part has been fitted to the connection groove, is attached to the fit part, and the engagement member has been attached to the engagement/disengagement operation body.

In this invention, it is possible to attach the band to the timepiece armor assembly by inserting the engagement member connected to the engagement/disengagement operation body into the engagement groove of the band connection part by operating the operation part of the engagement/disengagement operation body attached to the fit part after fitting the fit part provided in an end part of the band to the connection groove of the band connection part along the thickness direction. Further, by a procedure reverse to this, it is possible to detach the band from the timepiece armor assembly. In such an attachment/detachment of the band, since the connection groove and the fit part are large in their shapes, a mutual fit and its release are easy. Moreover, the attachment or the detachment of the fit part to or from the band connection part can be performed along their thickness directions. Besides, since the operation part of the engagement/disengagement operation body is disposed in the exposed face of the fit part exposed in the back face or the front face of the band connection part, when operating the operation part, there is no fact that the band connection part of the timepiece armor assembly becomes the obstacle, so that the operation part can be operated in a wide work space.

Further, in a preferred mode of the present invention, the engagement groove, the engagement/disengagement operation body and the engagement member are provided respectively in plural number. In this invention, since the fit part of the band can be engaged with the band connection part by causing the engagement member to enter into the engagement groove in plural places, it is possible to more stabilize an attached state of the band.

Further, in a preferred mode of the present invention, a thickness of the engagement member is made larger than a dimension of the engagement groove along a thickness direction of the band connection part and, by providing tapers in both front/back faces of an edge part of the engagement member, this edge part is formed taperingly. In this invention, even if there are dispersions in component dimensions, positions and the like of the band connection part, the engagement groove, the fit part of the band, the engagement/disengagement operation body and the engagement member, it is possible to attach the band to the timepiece armor assembly by causing the engagement member to surely enter into the engagement groove.

Further, in a preferred mode of the present invention, the band connection part has a cover region which covers the fit part from a front side. In this invention, when the wristwatch has been mounted to a human body's wrist, since it is possible to prevent the connection groove, the fit part and the operation part from being seen by the cover region of the band connection part cover-concealing these groove and parts, an external appearance of the wristwatch can be made into desirable one.

### BRIEF DESCRIPTION OF THE SEVERAL VIEWS OF THE DRAWINGS

A preferred form of the present invention is illustrated in the accompanying drawings in which:

FIG. 1 is a plan view showing a wristwatch concerning a 1st embodiment of the present invention;

FIG. 2 is a plan view showing surroundings of a band connection part of the wristwatch of FIG. 1;

FIG. 3 is a back face view showing the surroundings of the band connection part of the wristwatch of FIG. 1, in its connection state;

FIG. 4 is a sectional view showing along an F4-F4 line in FIG. 3;

FIG. 5 is a back face view showing the surroundings of the band connection part of the wristwatch of FIG. 1, in its connection release state;

FIG. 6 is a sectional view showing along an F6-6 line in FIG. 5; and

FIG. 7 is a back face view showing the surroundings of the band connection part of a wristwatch concerning a 2nd embodiment of the present invention, in its connection state.

### DETAILED DESCRIPTION OF THE PREFERRED EMBODIMENTS

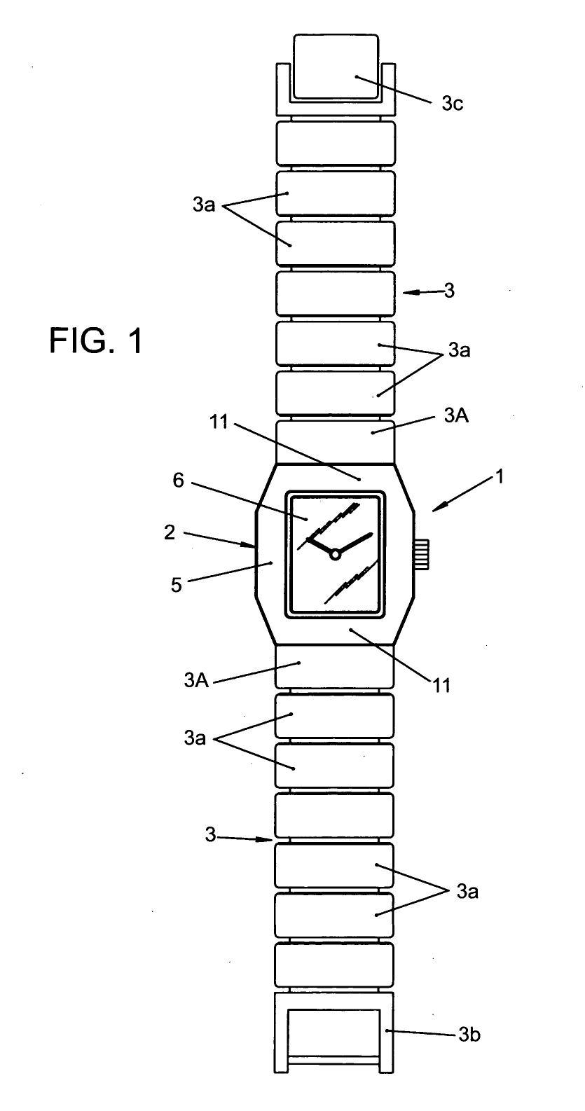

A 1st embodiment of the present invention is explained by referring to FIG. 1-FIG. 6.

In a wristwatch 1 shown in FIG. 1, a band 3 is attached to a timepiece armor assembly 2. The timepiece armor assembly 2 possesses a constitution in which a transparent member, e.g., a glass 6, causing a dial to be seen is mounted to a front face of a case band 5 made of a metal for instance, and a case back not shown in the drawing has been detachably screwed in to a back face of the case band 5. In this timepiece assembly 2, there are accommodated the dial, a timepiece movement not shown in the drawing, and the like.

The case band 5 of the timepiece armor assembly 2 monolithically has band connection parts 11 corresponding to 6 o'clock and 12 o'clock sides of the dial and, as mentioned later, the band 3 is detachably attached to each of these band connection parts 11. The band 3 is made of the same material as the case band 5, e.g., the same metal as the case band 5, and plural band pieces 3a are connected through bar-like piece connection members not shown in the drawing. The adjoining band pieces 3a are connected so as to be totatable with the piece connection member being made a center. For the band piece 3a, it is good to use the same metal as the case band 5, desirably a metal whose color has been made the same. Incidentally, in FIG. 1, a reference numeral 3b denotes a hook bridge of the band 3, and a reference numeral 3c denotes a hook, of the band 3, capable of engaging with or disengaging from the hook bridge 3b. By engaging the hook 3c with the hook bridge 3b under a wound state of the band 3 to the human body's wrist, the wound state of the band 3 to the wrist is retained.

Among the band pieces 3a, a band piece 3A located in an end part of the timepiece armor assembly 2 side has a fit part 21 while differing from other band piece 3a, and functions as a connection piece detachably connected to the band connection part 11.

Next, a constitution for attaching or detaching the band 3 to or from the timepiece armor assembly 2 by possessing the band connection part 11 and the fit part 21 etc. is explained.

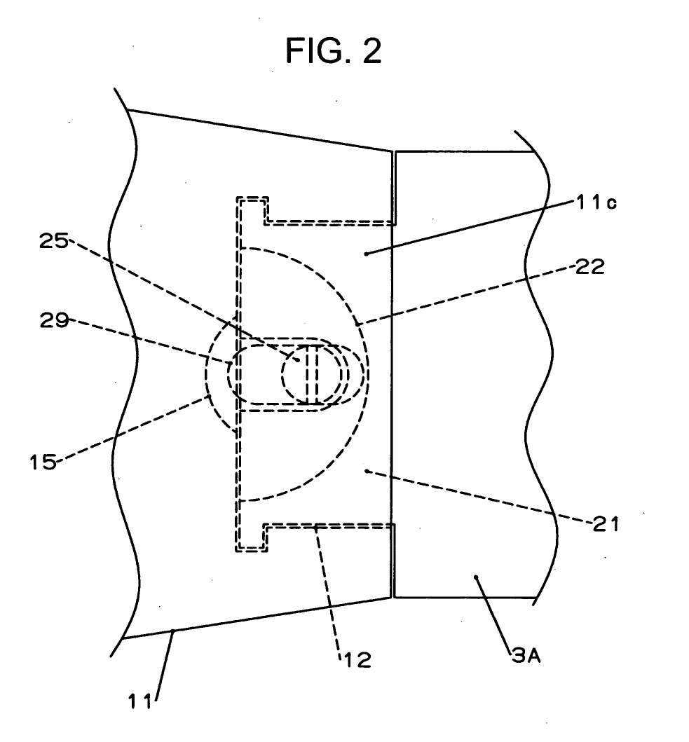

As shown in FIG. 2 to FIG. 6, a connection groove 12 and an engagement groove 15 are respectively provided in the band connection part 11. As shown in FIG. 4 and FIG. 6, the band connection part 11 has a cover region 11c located in a front side for instance.

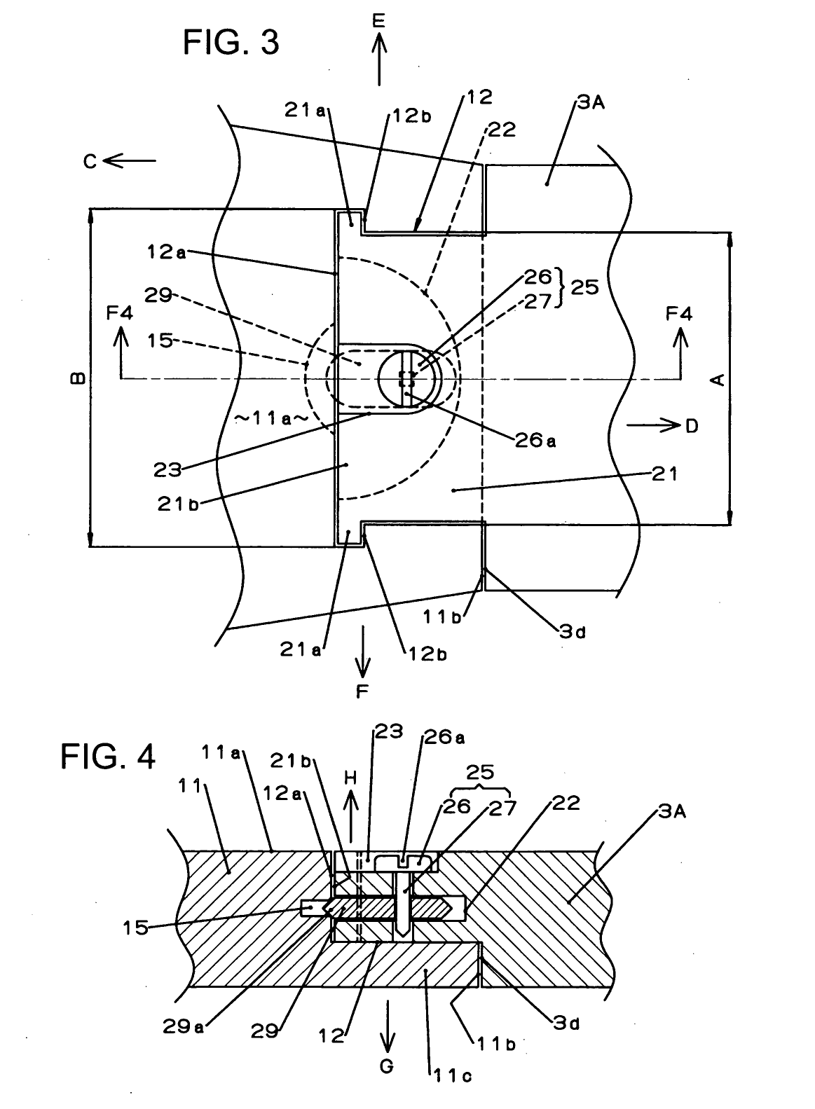

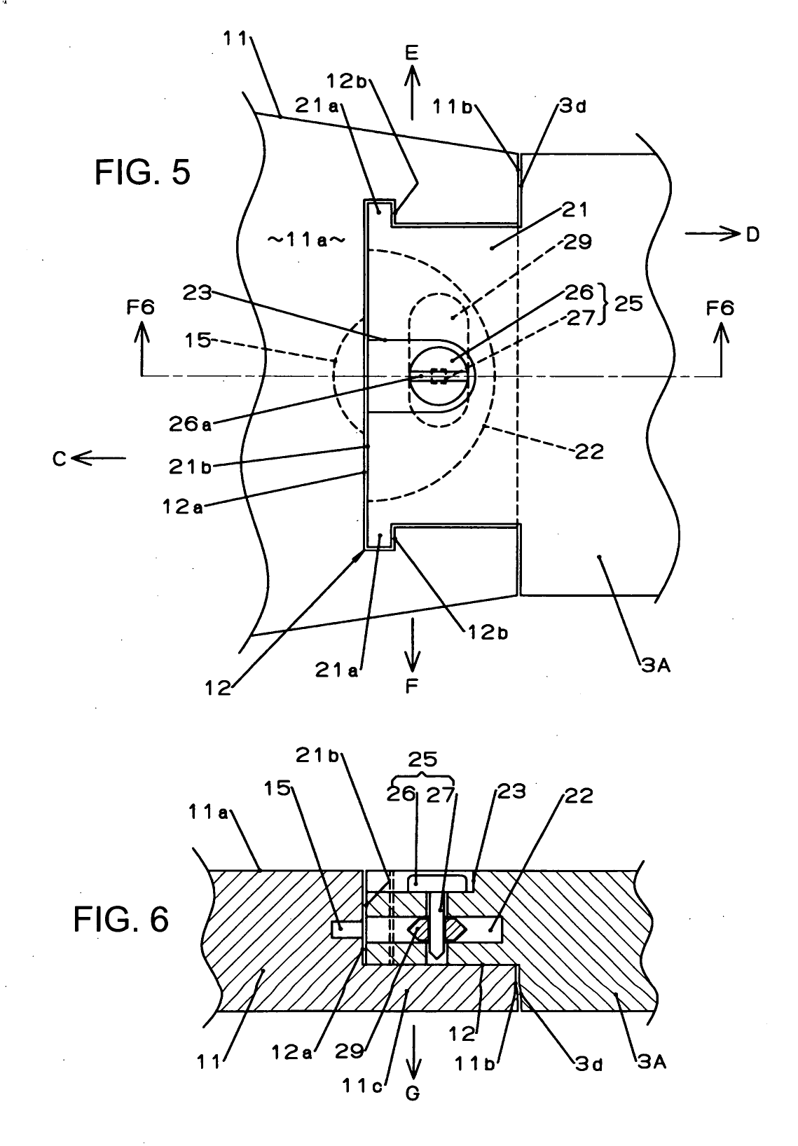

The connection groove 12 is provided while being opened respectively to a back face 11a and an end face 11b of the band connection part 11. An interior part of the connection groove 12 has a shape formed wider than an open end of the connection groove 12 opened to the above end face 11b, and is formed in an approximately T-shaped form in a case where, for example, the band connection part 11 is seen from a back side. In FIG. 3, a sign A denotes a width of the above open end of the band connection part 11, and B denotes a width of the interior part of the band connection part 11. Additionally, in FIG. 3 and FIG. 5, a reference numeral 12a denotes an interior face of the connection groove 12 parallel to the above end face 11b, and 12b is a face defining one part of the widened interior part of the connection groove 12, and this face 12b is parallel to the interior face 12a for instance.

The engagement groove 15 is formed in the band connection part 11 while facing on the connection groove 12. This engagement groove 15 has a crescent shape in plan view, and is provided with a portion corresponding to a subtense of that shape being opened to the interior face 12a for instance.

The fit part 21 of the band piece 3A has a shape, e.g., the approximately T-shaped form, coinciding with the connection groove 12, and can be fitted to this connection groove 12 detachably along a thickness direction of the band connection part 11. Incidentally, in FIG. 3 and FIG. 5, a reference numeral 21a denotes a protrusion part of the fit part 21. This protrusion part 21a is detachably fitted between the interior face 12a and the face 12b which are mutually parallel. Further, in FIG. 3 to FIG. 6, a reference numeral 21b denotes an opposed face which, under a state that the fit part 21 has been fitted to the connection groove 12, faces at the very short distance on the interior face 12a of the connection groove 12 to which the engagement groove 15 has been opened.

In the fit part 21, there is formed an escape hole 22, of a semicircular shape for instance, opening to the opposed face 21b of the fit part. Additionally, under the state that the fit part 21 has been fitted to the connection groove 12, in one face of the fit part 21 exposed to an outside of the connection groove 12, concretely in a back face of the fit part 21 in the present embodiment, there is formed a concave part 23 having a U shape for instance.

An engagement/disengagement operation body 25 and an engagement member 29 are attached to the fit part 21. The engagement/disengagement operation body 25 consists of an operation part 26 and an axle 27.

The axle 27 reaches to the escape hole 22 while penetrating through a bottom wall of the concave part 23, and is, e.g., rotatably attached to the fit part 21. The operation part 26 is a circular shape for instance, and accommodated in the concave part 23 with its center part being connected to the axle 27. The operation part 26 is a member for reciprocation-moving the engagement member 29 by a rotary motion for instance. As a desirable example, this operation part 26 has a groove 26a into which an edge part of a coin can enter such that it can be rotation-operated by using a daily popularized article (for example, coin, driver for screwing, and the like) without using a tool for exclusive use such as a driver for timepiece and a pair of tweezers.

A portion, of the axle 27, located in the escape hole 22 is formed in an angular shape in section, and to this portion there is connected an axial one end part of the engagement member 29 consisting of an oval flat plate. By rotating the operation part 26, the engagement member 29 is moved over between an insertion position where it is inserted into the escape hole 22 as shown in FIG. 5 and FIG. 6 and a protrusion position where its free end part protrudes from the opposed face 21b to thereby engage with the engagement groove 15 as shown in FIG. 3 and FIG. 4.

As shown in FIG. 4 and FIG. 6, a plate thickness of the engagement member 29 is thicker than a height (dimension along a thickness direction of the band connection part 11) of the engagement groove 15. Among edge parts of this engagement member 29, in both front/back faces of an edge part 29a of at least the above free end part, tapers are respectively provided. By this, the edge part 29a (refer to FIG. 4) is formed taperingly.

The band 3 is attached to the timepiece armor assembly 2 by the following procedures.

First, under a state that the timepiece armor assembly 2 has been reversed, the fit part 21 of the band piece 3A is fitted from above to the connection groove 12, of the band connection part 11, opened upward. This fit is performed under the state that the engagement member 29 has been inserted into the escape hole 22. A state that the fit part 21 has been fitted to the connection groove 12 is shown in FIG. 5 and FIG. 6.

Next, by using the article such as coin, the engagement/disengagement operation body 25 is rotated by approximately 90° in a counterclockwise direction in FIG. 5. By this, the engagement member 29 is protruded from the escape hole 22 and fit-inserted into the engagement groove 15 facing on this escape hole 22 at the very short distance while engaging with the engagement grove, so that the fit part 21 is fixed to the band connection part 11. The state wherein the band 3 has been attached to the timepiece armor assembly 2 in this manner is shown in FIG. 3 and FIG. 4.

Under the state that the band 3 has been attached, the band 3 is regulated in its movement in an arrow C direction in FIG. 3 and FIG. 5 by the interior face 12a of the connection groove 12, the opposed face 21b of the fit part 21 facing on the former face at the very short distance, the end face 11b of the band connection part 11, a shoulder face 3d (refer to FIG. 3 to FIG. 6) of the band piece 3A facing on the former face at the very short distance, and the like. And, by the catching between the face 12b of the connection groove 12 and the protrusion part 21a of the fit part 21, which are faced at the very short distance, the band 3 is regulated in its movement in an arrow D direction in FIG. 3 and FIG. 5. Like this, the band 3 is regulated in its movement along a direction connecting 6 o'clock-12 o'clock of the dial.

Further, by width-wise faces, which are faced at the very short distance, of the connection groove 12 and the fit part 21 which have been mutually fitted, the band 3 is regulated in its movement in a direction (arrow E direction and arrow F direction in FIG. 3 and FIG. 5) connecting 3 o'clock-9 o'clock of the dial. Additionally, by the cover region 11c, of the band connection part 11, covering the fit part 21, it is also regulated that the fit part 21 of the band 3 moves upward (arrow G direction in FIG. 4 and FIG. 6). Moreover, by the fact that the engagement member 29 is fit-inserted into the engagement groove 15 and caught thereby, it is also regulated that the fit part 21 of the band 3 moves downward (arrow H direction in FIG. 4).

In addition, as mentioned already, by the rotation operation of the engagement/disengagement operation body 25, since the engagement member 29 is fit-inserted into the engagement groove 15 while engaging it, with this behavior the protrusion part 21a of the fit part 21 is closely contacted with the face 112b of the connection groove 12. By this, a backlash of the fit part 21 fitted to the connection groove 12 is suppressed. Together with this, in a case where the band piece 3A is subjected to such an external force that it is slanted to a back side of the band connection part 11 with the protrusion part 21a of the fit part 21 being made a supporting point, the interior face 12a and opposed face 21b, the end face 11b and the shoulder face 3d, and the face 12b and the protrusion part 21a, which are respectively faced at the very short distance as mentioned already, vie with each other in the respective places, so that a slant motion of the fit part 21 with respect to the band connection part 11 is suppressed. As a result, a fit insertion state of the engagement member 29 into the engagement groove 15 is maintained.

Accordingly, it is possible to retain the band 3 having been attached to the band connection part 11, under the state that the fit part 21 of the band 3 has been regulated with respect to the band connection part 11 in all of the movement along the direction connecting 6 o'clock-12 o'clock, the movement along the direction connecting 3 o'clock-9 o'clock, and the movement along the thickness direction of the band connection part 11.

The band 3 can be detached from the time piece armor assembly 2 by the following procedures.

First, under the state that the timepiece armor assembly 2 has been reversed, the engagement/disengagement operation body 25 is rotated by approximately 90° in the counterclockwise direction in FIG. 3 by using the article such as coin from above the fit part 21 of the band piece 3A exposed upward. By this, as shown in FIG. 5 and FIG. 6, the engagement member 29 is disengaged from the engagement groove 15, the fixation of the fit part 21 with respect to the band connection part 11 is released, and the engagement member 29 is accommodated into the escape hole 22. Next, the fit part 21 of the band 3 is pull-disengaged above the connection groove 12 of the band connection part 11. By this, it is possible to detach the band 3 from the timepiece armor assembly 2.

By the way, shapes of the connection groove 12 and the fit part 21 are far large in comparison with the pin of the conventional spring bar and a small hole into which or from which this pin is inserted or pulled out. For this reason, in the above-explained attachment/detachment operation of the band 3 to/from the timepiece armor assembly 2, it is easy to perform the operation mutually fitting the connection groove 12 and the fit part 21, and the operation releasing this fit to thereby mutually separate them. In addition, when attaching or detaching the fit part 21 to or from the connection groove 12, not only it is unnecessary to perform the work while resisting against the biasing force of the spring like the case where the spring bar has been used, but also the work can be performed along the thickness directions of the band connection part 11 and the fit part 21. Besides, since the operation part 26 of the engagement/disengagement operation body 25 is disposed in the exposed face of the fit part 21 exposed in the back face of the band connection part 11, when rotation-operating the operation part 26, there is no fact that the band connection part 11 of the timepiece armor assembly 2 becomes the obstacle, so that the operation part 26 can be operated in the wide work space.

Accordingly, in this wristwatch 1, the band 3 can be easily attached to or detached from the timepiece armor assembly 2. By this, an assembly workability in producing the wristwatch 1 can be improved.

Moreover, in the above-explained attachment/detachment of the band 3, since the operation part 26 can be simply rotation-operated by using the coin and the like without requiring the tool for exclusive use, also for a user of the wristwatch 1 it is possible to simply perform the attachment/detachment operation mentioned already. For this reason, by previously preparing the bands 3 of various designs which have the fit part 21 as a common constitution and are different in their mutual colors and shapes, it becomes possible that the user selects an optional band from among the prepared band group and uses it by attaching it to the timepiece armor assembly 2. Like this, by the fact that the desired band can be simply exchanged to the timepiece armor assembly 2 at a suitable time, it is possible to use the wristwatch 1 while variously differentiating its design by a combination of the common timepiece armor assembly 2 and the selected band 3.

Further, since the engagement member 29 is thicker than the engagement groove 15 and its edge part 29a is formed taperingly by the tapers of the both front/back faces, it is possible to cause the engagement member to surely enter into the engagement groove 15 even if there are dispersions in component dimensions, positions: and the like of the band connection part 11, the engagement groove 15, the fit part 21 of the band 3, the engagement/disengagement operation body 25, the engagement member 29, and the like. By this, it is possible to surely attach the band 3 to the timepiece armor assembly 2.

Further, the band connection part 11 has a cover region 11c covering the fit part 21 of the band 3, which has been attached to the band connection part, from the front side. For this reason, when the wristwatch 1 is mounted to the human body's wrist, it is possible to prevent the connection groove 12, the fit part 21 and the operation part 26 from being seen by the cover region 11c cover-concealing these groove and parts, so that the external appearance of the wristwatch 1 can be made into desirable one. Moreover, as shown in FIG. 1 and FIG. 2, it is desirable in an external appearance also in a point that the band connection part 11 and the band piece 3A are provided so as to apparently, monolithically continue.

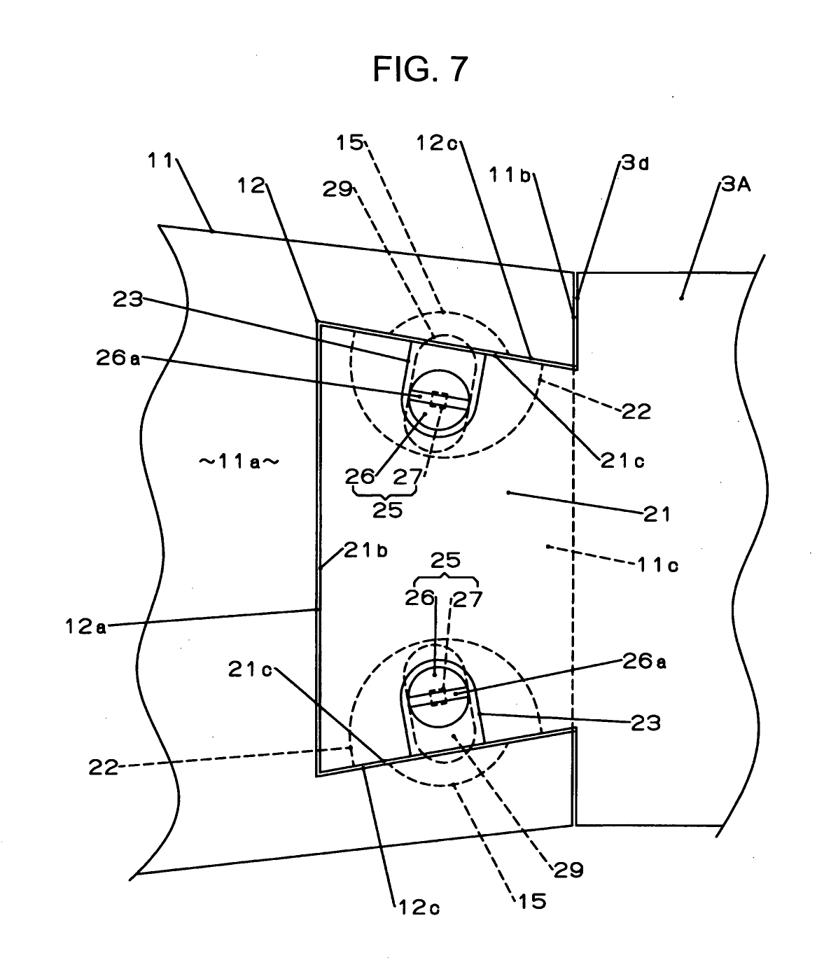

FIG. 7 shows a 2nd embodiment of the present invention. Since this embodiment is basically the same as the 1st embodiment, as to the same portion as the 1st embodiment, the same reference numeral is applied and the explanation is omitted, and hereunder a constitution different from the 1st embodiment is explained.

In the 2nd embodiment, under a state that the fit part 21 is not fitted, by making opposed groove side faces 12c of the connection groove 12 into taper faces whose mutual spacing becomes gradually narrow as approaching the end face 11b, the connection groove 12 is made into a so-called dovetail groove-like structure, in other words, a mortise whose interior is wider than its inlet. By this, the connection groove 12 is made into a shape in which an interior part of the connection groove 12 is formed wider than an open end opened in the end face 11b. Additionally, the engagement groove 15 is provided in plural number, e.g., while being respectively opened to one pair of groove side faces 12c.

The fit part 21 of the band piece 3A has a convex part shape which coincides with a shape of the connection groove 12 and whose root has been constricted, and is made in a so-called dovetail tenon shape. Under a state that the fit part 21 has been fitted to the connection groove 12, the groove side face 12c and an opposed face 21c facing on the engagement groove 15 at the very short distance consist of one pair of faces having the taper of the fit part 21. To the fit part 21, there are attached plural, e.g., one pair of, engagement/disengagement operation bodies 25 correspondingly to the number of the engagement grooves 15. The engagement members 29 of these engagement/disengagement operation bodies 25 are individually inserted into or detached from the engagement groove 15 while protruding into or retracting from the above opposed face 21c.

Points other than the point explained above are the same as the 1st embodiment while including the constitution not shown in FIG. 7. Accordingly, also in this 2nd embodiment, similarly to the 1st embodiment, when attaching or detaching the band 3 to or from the timepiece armor assembly 2, since there is no fact that the timepiece assembly 2 becomes the obstacle and thus the work space is limited, it is possible to provide the wristwatch 1 in which the band 3 can be easily attached or detached. Moreover, since the fit part 21 of the band 3 can be engaged with the band connection part 11 by respectively causing the engagement members 29 enter into the engagement grooves 15 in the plural places, it is possible to more stabilize the attached state of the band 3.

Incidentally, the present invention is not limited to the above both embodiments. For example, in the present invention, in the constitution in which the operation part 26 is rotation-operated, the engagement member 29 may be made into an eccentric disc, and the axle 27 of the engagement/disengagement operation body 25 may be connected to an eccentric position deviated from a center of the eccentric disc. Further, a marking, such as point and line, to which one end of the groove 26a is aligned with the rotation operation of the operation part 26 is provided around the operation part 26, and it is possible to make this marking into a measure for causing a position of the engagement member 29 moved by the rotation operation of the engagement/disengagement operation body 25 to be visually understood.

Further, the present invention can adopt also the following constitution instead of the engagement/disengagement operation body which is rotation-operated. For example, the engagement member 29 capable of being protruded into or retracted from the opposed face 21b or the opposed face 21c is slidably accommodated in the escape hole 22 formed so as to guide this reciprocating movement, and this engagement member 29 is biased in a direction along which it protrudes from the opposed face 21b or the opposed face 21c by a biasing body, such as spring, accommodated in the escape hole 22. For this reason, by retracting the engagement member 29 into the escape hole 22 through the operation part 26 while resisting against the biasing body, it is possible to detach the band 3 from the band connection part 11 by disengaging this engagement member 29 from the engagement groove 15. And, it is possible to attach the band 3 to the band connection part 11 by protruding the engagement member 29 by a biasing force of the biasing body to thereby cause it to enter into the engagement groove 15 by releasing an operation force applied to the operation part 26.

Further, in the present invention, instead of the fact that the edge of the engagement member 29 is formed taperingly, it is also possible to gradually narrow the engagement groove 15 as going from its open end to its interior, and make a thickness of the engagement member 29 narrower than a height dimension of the open end of the engagement groove 15.

Further, the cover region 11c of the band connection part 11 may be provided so as to cover the connection groove 12 and the fit part 21, which have been mutually fitted, from the back face side of the band connection part 11. In this case, it is possible to attach or detach the band 3 without reversing the wristwatch 1.

According to the present invention, when attaching or detaching the band to or from the timepiece armor assembly, since there is no fact that the work space is limited with the timepiece armor assembly becoming the obstacle, it is possible to provide a wristwatch in which the band can be easily attached or detached.

1. A wristwatch comprising:
a band connection part of a timepiece armor assembly, wherein there are provided respectively a connection groove which opens respectively to a front face or a back face and an end face of this connection part and whose interior has been formed wider than an open end of the end face, and an engagement groove opening to this connection groove,
a fit part detachably fitted to the connection groove, which is provided in an end part of a band attached to or detached from the band connection part,
an engagement member, which is protruded into or retracted form an opposed face facing on the engagement groove under a state that the fit part has been fitted to the connection groove and thereby inserted into or detached from the engagement groove, is attached to the fit part,
an engagement/disengagement operation body, which has an operation part disposed in an exposed face of the fit part exposed in the back face or the front face of the band connection part under the state that the fit part has been fitted to the connection groove, is attached to the fit part, and
wherein the engagement member has been attached to the engagement/disengagement operation body.

2. A wristwatch according to claim 1, wherein the engagement groove, the engagement/disengagement operation body and the engagement member have been provided respectively in plural number.

3. A wristwatch according to claim 1, wherein a thickness of the engagement member is made larger than a dimension of the engagement groove along a thickness direction of the band connection part and, by providing tapers in both front/back faces of an edge part of the engagement member, this edge part has been formed taperingly.

4. A wristwatch according to claim 1, wherein the band connection part has a cover region which covers the fit part from a front side.
